(19) United States
(12) Patent Application Publication
(10) Pub. No.: US 2025/0174973 A1
(43) Pub. Date: May 29, 2025

(54) WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hideaki ITO, Osaka (JP); Daichi ASHIDA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/728,257

(22) PCT Filed: Jan. 12, 2023
(86) PCT No.: PCT/JP2023/000559

§ 371 Date: Jul. 11, 2024

(30) Foreign Application Priority Data
Jan. 31, 2022 (JP) 2022-012776

(51) Int. Cl. H02G 3/30; H01B 7/00

(52) U.S. Cl. CPC H02G 3/30; H01B 7/0045

(57) ABSTRACT

A wire harness includes plural types of connectors connected to connection destinations different from each other and a plurality of wirings connecting the plural types of connectors to each other. The plural types of connectors include an apparatus connector connected to a connector of an apparatus and plural types of harness connectors to which connectors of counterpart wire harnesses different from each other are connected, respectively. The plurality of wirings include a through circuit wiring connecting a first harness connector and a second harness connector in the plural types of harness connectors and a plurality of apparatus wirings connecting the apparatus connector to the first harness connector and the second harness connector.

### TECHNICAL FIELD

The present disclosure relates to a wire harness.

### BACKGROUND ART

Patent Document 1 discloses an interconnection box electrically interconnecting an instrument panel harness, an engine room harness, a door harness, and a floor harness.

### PRIOR ART DOCUMENTS

### Patent Document(s)

Patent Document 1: Japanese Patent Application Laid-Open No. 2007-202352

### SUMMARY

### Problem to be Solved by the Invention

Desired is simplification of connection between plural types of counterpart wire harness and connection between the plural types of counterpart wire harness and an apparatus.

Accordingly, an object is to provide a technique capable of simplifying connection between plural types of counterpart wire harness and connection between the plural types of counterpart wire harness and an apparatus.

### Means to Solve the Problem

A wire harness according to the present disclosure is a wire harness including: plural types of connectors connected to connection destinations different from each other; and a plurality of wirings connecting the plural types of connectors to each other, wherein the plural types of connectors include an apparatus connector connected to a connector of an apparatus and plural types of harness connectors to which connectors of counterpart wire harnesses different from each other are connected, respectively, and the plurality of wirings include at least one through circuit wiring connecting a first harness connector and a second harness connector in the plural types of harness connectors and a plurality of apparatus wirings connecting the apparatus connector to the first harness connector and the second harness connector.

### Effects of the Invention

According to the present disclosure, simplified is connection between plural types of counterpart wire harness and connection between the plural types of counterpart wire harness and an apparatus.

### BRIEF DESCRIPTION OF DRAWINGS

FIG. 1 is a perspective view illustrating a state where a wire harness according to an embodiment 1 is disposed in a vehicle.

FIG. 2 is a plan view illustrating the wire harness according to the embodiment 1.

FIG. 3 is a diagram explaining a correspondence relationship between plural types of connectors and a plurality of wirings.

FIG. 4 is a diagram explaining a correspondence relationship between an apparatus connector, a first harness connector, and a second harness connector.

FIG. 5 is an exploded plan view illustrating the wire harness according to the embodiment 1.

FIG. 6 is a cross-sectional view along a VI-VI line in FIG. 2.

FIG. 7 is a cross-sectional view illustrating a wire harness according to a first modification example.

FIG. 8 is an exploded plan view illustrating the wire harness according to the first modification example.

FIG. 9 is a plan view illustrating a wire harness according to a second modification example.

FIG. 10 is an exploded plan view illustrating a wire harness according to a third modification example.

FIG. 11 is a perspective view illustrating a wire harness according to a fourth modification example.

FIG. 12 is an exploded perspective view illustrating the wire harness according to the fourth modification example.

FIG. 13 is a cross-sectional view illustrating a wire harness according to a fifth modification example.

### DESCRIPTION OF EMBODIMENT(S)

### Description of Embodiments of Present Disclosure

Embodiments of the present disclosure are listed and described firstly.

A wire harness of the present disclosure has a configuration described hereinafter.

(1) A wire harness includes: plural types of connectors connected to connection destinations different from each other; and a plurality of wirings connecting the plural types of connectors to each other, wherein the plural types of connectors include an apparatus connector connected to a connector of an apparatus and plural types of harness connectors to which connectors of counterpart wire harnesses different from each other are connected, respectively, and the plurality of wirings include at least one through circuit wiring connecting a first harness connector and a second harness connector in the plural types of harness connectors and a plurality of apparatus wirings connecting the apparatus connector to the first harness connector and the second harness connector. By applying the wire harness according to the present disclosure including the through circuit wiring connecting the first harness connector and the second harness connector and the plurality of apparatus wirings connecting the apparatus connector to the first harness connector and the second harness connector as the plurality of wirings, simplified is connection between plural types of counterpart wire harness and connection between the plural types of counterpart wire harness and an apparatus.

(2) In the wire harness according to (1), it is applicable that some of the plurality of wirings are collected to constitute a first wiring group and another some of the plurality of wirings are collected separately from the first wiring group to constitute a second wiring group. Accordingly, the first wiring group and the second wiring group can be separately manufactured, and can be subsequently integrated to constitute the wire harness.

(3) In the wire harness according to (2), each of the first wiring group and the second wiring group may be flatly formed and stacked to each other. Accordingly, the wire harness can also be easily disposed in a narrow position in a vehicle.

(4) In the wire harness according to (3), each of the first wiring group and the second wiring group may include a plurality of electrical wires and at least one flat base member keeping the plurality of electrical wires flat. Accordingly, each of the flat first wiring group and second wiring group is simply provided.

(5) In the wire harness according to (4), the plurality of base members may be provided at intervals along an extension direction of the plurality of electrical wires in a position corresponding to each of the first wiring group and the second wiring group. Accordingly, the plurality of electrical wires are easily bended in a portion between the plurality of base members compared with a portion where the plurality of base members are provided, and a difference of route or redundant length can be easily absorbed. Accordingly, a common wire harness can be easily applied to vehicles having different sizes.

(6) In the wire harness according to (4) or (5), it is applicable that the base member is a flexible sheet member, and the wire harness further includes a rigid member having higher rigidity than the sheet member and holding a wiring form of the first wiring group and the second wiring group. Accordingly, the rigid member is disposed in the vehicle, thus the wiring can be disposed along a predetermined route.

(7) In the wire harness according to any one of (2) to (6), it is applicable that more than half of the wirings in first wiring group is the apparatus wirings, and more than half of the wirings in second wiring group is the through circuit wirings. Accordingly, most of the apparatus wirings and most of the through circuit wirings can be separated.

(8) In the wire harness according to any one of (2) to (6), it is applicable that more than half of the wirings in first wiring group is signal lines, and a ratio of power source lines in the second wiring group is higher than a ratio of power source lines in the first wiring group. Accordingly, most of the power source lines and most of the signal lines can be separated.

(9) In the wire harness according to any one of (2) to (8), it is applicable that at least one of the plural types of connectors is made up of a plurality of split connectors, and the plurality of split connectors include a first split connector to which the first wiring group is connected and a second split connector to which the second wiring group is connected. Accordingly, it is easy to separately manufacture the first wiring group and the second wiring group and subsequently integrate them to constitute the wire harness.

(10) In the wire harness according to any one of (1) to (9), three or more types of harness connectors may be provided as the plural types of harness connectors. Accordingly, three or more types of counterpart wire harness and the apparatus can be connected by the wire harness.

(11) In the wire harness according to any one of (1) to (10), a length of each of the plurality of wirings may be equal or smaller than one meter. Accordingly, the wire harness can connect the apparatus and the counterpart wire harness in a narrow area in the vehicle.

(12) In the wire harness according to any one of (1) to (11), it is applicable that an arrangement area in a vehicle is an area where a dashboard panel and a cowl side panel intersect with each other, and two or more types of harness connectors selected from an engine room harness connector, an instrument panel harness connector, a door harness connector, and a floor harness connector are provided as the plural types of harness connectors. Accordingly, an operation of connecting the plural types of connectors is simply performed in the area where the dashboard panel and the cowl side panel intersect with each other in the vehicle.

(13) In the wire harness according to (12), it is applicable that the engine room harness connector, the instrument panel harness connector, the door harness connector, and the floor harness connector are provided as the plural types of harness connectors, a wiring part extending from the engine room harness connector is held to be disposed along the dashboard panel, the instrument panel harness connector, the door harness connector, and the floor harness connector are arranged side by side in a height direction, and a wiring part extending from each of the instrument panel harness connector, the door harness connector, and the floor harness connector is held to be disposed along the cowl side panel.

Accordingly, the instrument panel harness, the engine room harness, the door harness, and the floor harness can be connected to the engine room harness connector, the instrument panel harness connector, the door harness connector, and the floor harness connector, respectively, at positions close to wiring areas of the instrument panel harness, the engine room harness, the door harness, and the floor harness themselves.

### Detailed Description of Embodiment of Present Disclosure

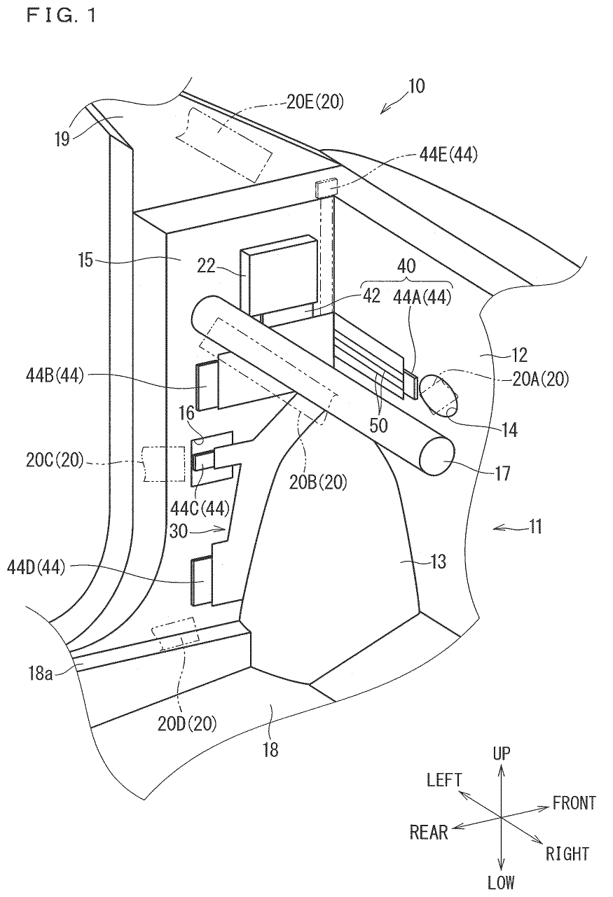

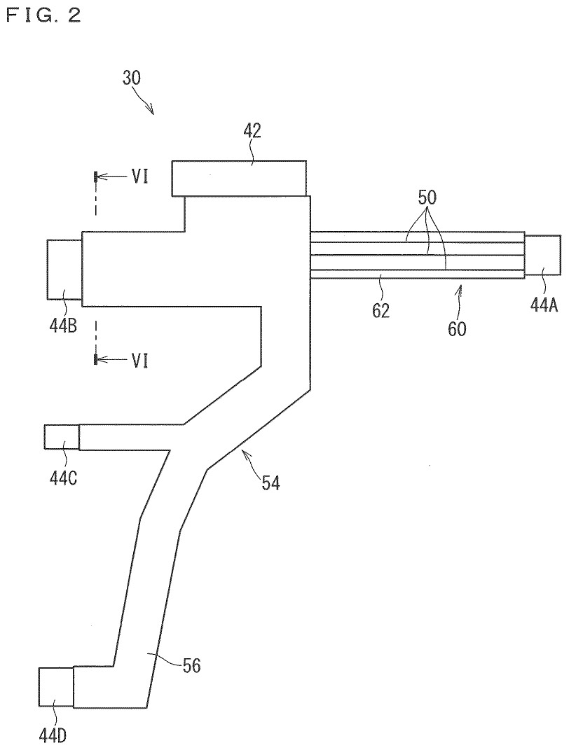

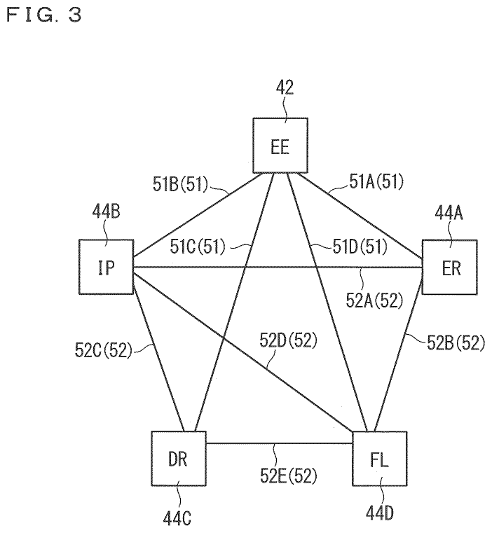

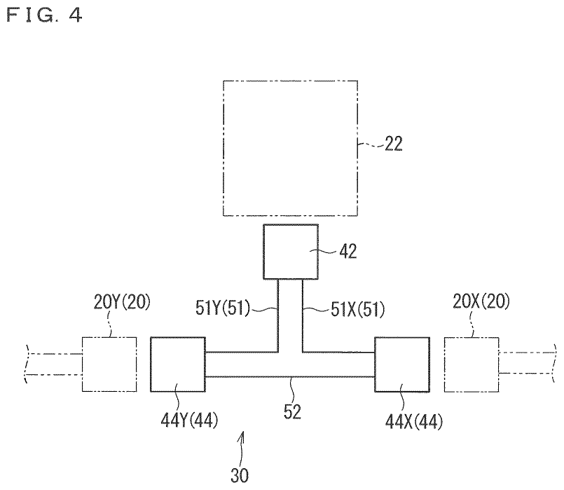

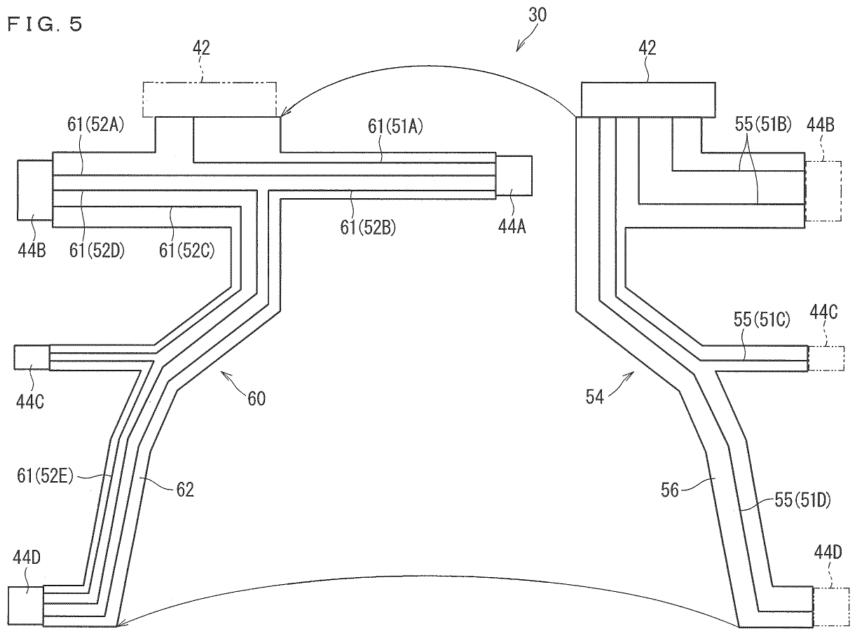

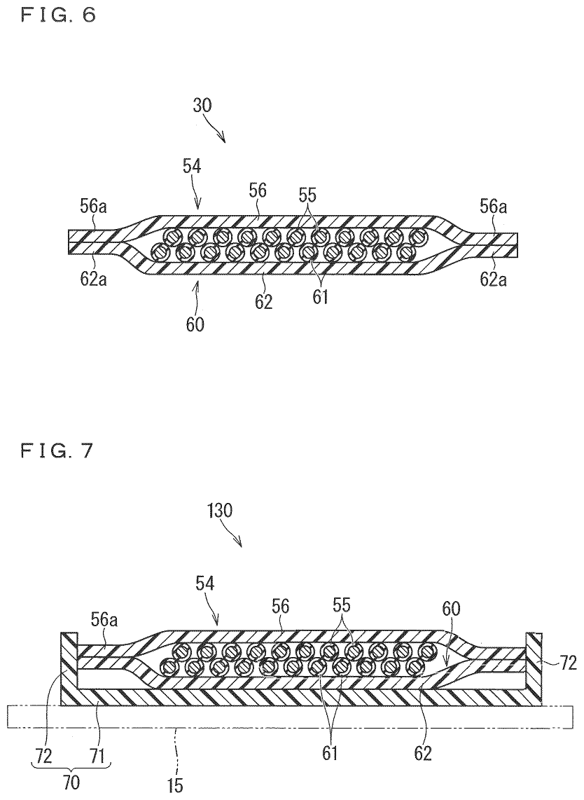

Specific examples of a wire harness of the present disclosure are described hereinafter with reference to the diagrams. The present disclosure is not limited to these examples, but is indicated by claims, and it is intended that meanings equivalent to claims and all modifications within a scope of claims are included.

[Embodiment 1] A wire harness according to an embodiment 1 is described hereinafter. FIG. 1 is a perspective view illustrating a state where a wire harness 30 according to the embodiment 1 is disposed in a vehicle 10. A front-back direction, a right-left direction, and an up-down direction illustrated in FIG. 1 correspond to a front-back direction, a right-left direction, and an up-down direction in the vehicle 10, respectively. FIG. 2 is a plan view illustrating a wire harness 30 according to the embodiment 1. FIG. 3 is a diagram explaining a correspondence relationship between plural types of connectors 40 and a plurality of wirings 50. FIG. 4 is a diagram explaining a correspondence relationship between an apparatus connector 42, a first harness connector 44X, and a second harness connector 44Y. FIG. 5 is an exploded plan view illustrating the wire harness 30 according to the embodiment 1. FIG. 6 is a cross-sectional view along a VI-VI line in FIG. 2.

The wire harness 30 is disposed in the vehicle 10, for example. The wire harness 30 intervenes between plural types of counterpart wire harness 20 and an apparatus 22 to connect the plural types of counterpart wire harness 20 to each other and connect each of the plural types of counterpart wire harness 20 to the apparatus 22. The plural types of counterpart wire harness 20 are disposed in areas different from each other in the vehicle 10.

An arrangement area of the wire harness 30, the counterpart wire harness 20, and the apparatus 22 in the vehicle 10 are firstly described for a purpose of convenience.

The arrangement area of the wire harness 30 in the vehicle 10 is not particularly limited, but can be appropriately set. When the intervention of the wire harness 30 between the plural types of counterpart wire harness 20 is considered, the arrangement area of the wire harness 30 is preferably an area close to boundaries of a plurality of areas where the plural types of counterpart wire harness 20 are disposed, respectively. In the description herein, the arrangement area of the wire harness 30 is an area where a dashboard panel 11 and a cowl side panel 15 intersect with each other.

The dashboard panel 11 partitions an engine room and a vehicle interior in the vehicle 10. An area closer to the front side than the dashboard panel 11 is the engine room, and an area closer to a rear side than the dashboard panel 11 is the vehicle interior. An instrument panel is normally provided closer to the rear side than the dashboard panel 11, and the instrument panel is exposed to the vehicle interior. The dashboard panel 11 includes a body part 12 and a protrusion part 13. A main surface of the body part 12 of the dashboard panel 11 extends in the right-left direction and an up-down direction in the vehicle 10. The protrusion part 13 is provided on a lower side of an end portion of the body part 12 in the right-left direction. The protrusion part 13 a part protruding to a side of the vehicle interior from the body part 12. The protrusion part 13 is a part for providing a wheel house to the vehicle 10.

The cowl side panel 15 is continuously formed with the dashboard panel 11 in each of a left side and a right side of the dashboard panel 11. A main surface of the cowl side panel 15 extends in the front-back direction and the up-down direction in the vehicle 10. FIG. 1 illustrates an area where the cowl side panel 15 provided on the left side of the dashboard panel 11 and the dashboard panel 11 intersect with each other. An edge portion on a lower front side of the cowl side panel 15 is bended in accordance with the protrusion part 13.

An end portion of an instrument panel reinforcement 17 is fixed to the cowl side panel 15. The instrument panel reinforcement 17 is provided between the dashboard panel 11 and the instrument panel. The instrument panel reinforcement 17 is a rod-like member elongated in the right-left direction.

A floor panel 18 is provided on a lower side of the area where the dashboard panel 11 and the cowl side panel 15 intersect with each other. A main surface of the floor panel 18 extends in the front-back direction and the right-left direction in the vehicle 10.

When the arrangement area of the wire harness 30 is the area where the dashboard panel 11 and the cowl side panel 15 intersect with each other, assumed as the counterpart wire harness 20 are an engine room harness 20A, an instrument panel harness 20B, a door harness 20C, and a floor harness 20D, for example. The engine room harness 20A is disposed in an engine room. The instrument panel harness 20B is disposed to extend along the instrument panel reinforcement 17. The door harness 20C is disposed in a door. The floor harness 20D is disposed along a floor. A roof harness 20E may be assumed as the counterpart wire harness 20. The roof harness 20E is disposed in a roof.

In the present disclosure, a term of engine room is an expediential address term of a front room located in front of a vehicle interior, thus an engine needs not necessarily be disposed in the engine room. In the similar manner, in the present disclosure, a term of the engine room harness 20A is an expediential address term of the counterpart wire harness 20 disposed in the front room located in front of the vehicle interior.

The arrangement area of the wire harness 30 and the arrangement area of the engine room harness 20A are partitioned by the dashboard panel 11. Herein, a through hole 14 is formed in the dashboard panel 11. The wire harness 30 and the engine room harness 20A are connected through the through hole 14. In the similar manner, the arrangement area of the wire harness 30 and the arrangement area of the door harness 20C are partitioned by the cowl side panel 15. Herein, a through hole 16 is formed in the cowl side panel 15. The wire harness 30 and the door harness 20C are connected through the through hole 16. A rocker part 18a, for example, is located in a side edge of the floor panel 18 in the vehicle. An end portion of the floor harness 20D connected to the wire harness 30 extends in a front-back direction of the vehicle along the rocker part 18a. The roof is located on an upper side of the area where the dashboard panel 11 and the cowl side panel 15 intersect with each other. For example, an end portion of the roof harness 20E connected to the wire harness 30 extends from the roof to the area where the dashboard panel 11 and the cowl side panel 15 intersect with each other or near the area along an A pillar 19.

The apparatus 22 is disposed in the same area as the arrangement area of the wire harness 30. In the example illustrated in FIG. 1, the apparatus 22 is fixed to the cowl side panel 15. The apparatus 22 may be fixed to the dashboard panel 11, the instrument panel reinforcement 17, or the floor panel 18, for example.

The apparatus 22 is an electrical control unit (ECU), for example. One central ECU and a plurality of zone ECUs may be provided in the vehicle 10. The zone ECU is provided for each zone sectioned into a plurality of areas in the vehicle 10. The zone ECU mainly controls the apparatus located in the zone. The central ECU achieves control of summing up the plurality of zone ECUs and collaborating in the whole vehicle 10. The apparatus 22 may be the zone ECU, for example. In this case, the apparatus 22 as the zone ECU controls a plurality of apparatuses as connection destinations of the engine room harness 20A, the instrument panel harness 20B, the door harness 20C, and the floor harness 20D, for example.

The apparatus 22 as the ECU may be a general ECU other than the zone ECU. The apparatus 22 needs not be the ECU, but may be a junction block (also referred to as an electrical junction box), for example.

The wire harness 30 includes plural types of connectors 40 and a plurality of wirings 50 connecting the plural types of connectors 40 to each other.

The plural types of connectors 40 are connected to connection destinations different from each other, respectively. The plural types of connectors 40 include an apparatus connector 42 and plural types of harness connectors 44. The apparatus connector 42 is connected to a connector of the apparatus 22. Connectors of the counterpart wire harness 20 different from each other are connected to the plural types of harness connectors 44, respectively. Herein, the engine room harness connector 44A, the instrument panel harness connector 44B, the door harness connector 44C, and the floor harness connector 44D are provided as the plural types of harness connectors 44. All of the engine room harness connector 44A, the instrument panel harness connector 44B, the door harness connector 44C, and the floor harness connector 44D need not be provided as the plural types of harness connectors 44, however, it is sufficient that two or more types of harness connectors 44 are provided. When the roof harness 20E is assumed as the counterpart wire harness 20, a roof harness connector 44E is provided as one type of the plural types of harness connectors 44. The roof harness connector 44E may be provided on an upper side of the apparatus connector 42, the engine room harness connector 44A, the instrument panel harness connector 44B, the door harness connector 44C, and the floor harness connector 44D in the vehicle, for example. The wiring connected to the roof harness connector 44E may extend in the up-down direction on a lateral side of the apparatus 22.

In the example illustrated in FIG. 2, each type of the connector 40 is one connector. That is to say, each of the apparatus connector 42, the engine room harness connector 44A, the instrument panel harness connector 44B, the door harness connector 44C, and the floor harness connector 44D is one connector. In the present disclosure, two or more connectors are considered one type of connector when the connection destination thereof is the same as each other. In other words, any number of connectors connected to the same apparatus 22 or the same counterpart wire harness 20 are considered one type of connector. From the other viewpoint, each of the plural types of connectors 40 is made up of one or more connectors (referred to as a split connector hereinafter). Each connector may include a connector having the same structure. Herein, the connectors having the same structure are considered different types of connector when the connection destinations thereof are different from each other.

At least one of the plural types of connectors 40 may include two or more split connectors. For example, the connector 40 having a largest number of electrodes (apparatus connector 42, for example) in the plural types of connectors 40 may include two or more split connectors. Accordingly, the connector 40 having the largest number of electrodes in the plural types of connectors 40 can be easily manufactured.

When the connector 40 includes the plurality of split connectors, it is preferable that the plural types of connectors 40 are four or more types of connector, and the number of the split connectors is equal to or smaller than N. Herein, N is a number obtained by subtracting two from the number of types of the plural types of connectors 40 in the wire harness 30. Accordingly, the number of groups of connectors to be fitted can be reduced compared with a case where the other type of connector 40 is connected to the connection destination of one type of connector 40. Specifically, the connectors 40 in the wire harness 30 are five types of connector 40 of the apparatus connector 42, the engine room harness connector 44A, the instrument panel harness connector 44B, the door harness connector 44C, and the floor harness connector 44D. Thus, when each of the apparatus connector 42, the engine room harness connector 44A, the instrument panel harness connector 44B, the door harness connector 44C, and the floor harness connector 44D includes a plurality of split connectors, the number thereof is preferably three or less. For example, when each of four counterpart wire harnesses 20 of the engine room harness 20A, the instrument panel harness 20B, the door harness 20C, and the floor harness 20D is connected to the apparatus 22, four groups of connectors need to be fitted. In contrast, when the apparatus connector 42 is made up of three or less split connectors, the number of groups of the connectors to be fitted can be three or less.

The plurality of wirings 50 include a through circuit wiring 52 and a plurality of apparatus wirings 51. The through circuit wiring 52 connects the harness connectors 44. The apparatus wiring 51 connects the apparatus connector 42 and the harness connector 44.

As illustrated in FIG. 3, apparatus wirings 51A, 51B, 51C, and 51D are provided as the apparatus wiring 51 herein. The apparatus wiring 51A connects the engine room harness connector 44A and the apparatus connector 42. The apparatus wiring 51B connects the instrument panel harness connector 44B and the apparatus connector 42. The apparatus wiring 51C connects the door harness connector 44C and the apparatus connector 42. The apparatus wiring 51D connects the floor harness connector 44D and the apparatus connector 42. The number of each of the apparatus wirings 51A, 51B, 51C, and 51D may be one or more.

As illustrated in FIG. 3, through circuit wirings 52A, 52B, 52C, 52D, and 52E are provided herein as the through circuit wiring 52. The through circuit wiring 52A connects the engine room harness connector 44A and the instrument panel harness connector 44B. The through circuit wiring 52B connects the engine room harness connector 44A and the floor harness connector 44D. The through circuit wiring 52C connects the instrument panel harness connector 44B and the door harness connector 44C. The through circuit wiring 52D connects the instrument panel harness connector 44B and the floor harness connector 44D. The through circuit wiring 52E connects the door harness connector 44C and the floor harness connector 44D. The number of each of the through circuit wirings 52A, 52B, 52C, 52D, and 52E may be one or more.

Accordingly, the wiring 50 is provided to nine routes other than one route between the engine room harness connector 44A and the door harness connector 44C in ten routes of five types of connectors 42 and 44.

As illustrated in FIG. 4, in the present disclosure, the plural types of harness connectors 44 include the first harness connector 44X and the second harness connector 44Y. The first harness connector 44X is connected to a first counterpart wire harness 20X. The second harness connector 44Y is connected to a second counterpart wire harness 20Y. Three types of connectors 42 and 44 of the apparatus connector 42, the first harness connector 44X, and the second harness connector 44Y are connected to each other by the wiring 50. Specifically, the first harness connector 44X and the second harness connector 44Y are connected to the apparatus connector 42 by the plurality of apparatus wirings 51. A first apparatus wiring 51X connects the apparatus connector 42 and the first harness connector 44X. A second apparatus wiring 51Y connects the apparatus connector 42 and the second harness connector 44Y. The through circuit wiring 52 connects the first harness connector 44X and the second harness connector 44Y. Described is whether four types of harness connectors 44 of the engine room harness connector 44A, the instrument panel harness connector 44B, the door harness connector 44C, and the floor harness connector 44D fall under the first harness connector 44X and the second harness connector 44Y.

Six groups of connectors are generated as a combination made by selecting two of four types of harness connectors 44 of the engine room harness connector 44A, the instrument panel harness connector 44B, the door harness connector 44C, and the floor harness connector 44D. Each of five of six groups except for one group made up of the engine room harness connector 44A and the door harness connector 44C includes the through circuit wiring 52 connecting two types of harness connectors 44 in each of five groups. All of four types of harness connectors 44 of the engine room harness connector 44A, the instrument panel harness connector 44B, the door harness connector 44C, and the floor harness connector 44D are connected to the apparatus connector 42 via the apparatus wiring 51. Thus, five of six groups except for one group made up of the engine room harness connector 44A and the door harness connector 44C can be considered the combination of the first harness connector 44X and the second harness connector 44Y.

In the meanwhile, the wire harness 30 does not include herein the through circuit wiring 52 connecting the engine room harness connector 44A and the door harness connector 44C. Thus, the engine room harness connector 44A and the door harness connector 44C are not considered the combination of the first harness connector 44X and the second harness connector 44Y herein.

It is applicable that three or more types of harness connectors 44 are provided as the plural types of harness connectors 44, and the wire harness 30 includes the through circuit wiring 52 connecting three or more types of harness connectors 44. Four groups of connectors are generated as a combination made by selecting three of four types of harness connectors 44 of the engine room harness connector 44A, the instrument panel harness connector 44B, the door harness connector 44C, and the floor harness connector 44D. Each of two of four groups except for two groups including the engine room harness connector 44A and the door harness connector 44C together includes the through circuit wiring 52 connecting three types of harness connectors 44 in each of four groups. Each of two of four groups except for two groups including the engine room harness connector 44A and the door harness connector 44C together can be considered the three or more types of harness connectors 44.

Specifically, the engine room harness connector 44A, the instrument panel harness connector 44B, and the floor harness connector 44D are connected to each other via the through circuit wirings 52A, 52B, and 52D. Thus, a combination of the engine room harness connector 44A, the instrument panel harness connector 44B, and the floor harness connector 44D can be considered the three or more types of harness connectors 44. In the similar manner, the instrument panel harness connector 44B, the door harness connector 44C, and the floor harness connector 44D are connected to each other via the through circuit wirings 52C, 52D, and 52E. Thus, a combination of the instrument panel harness connector 44B, the door harness connector 44C, and the floor harness connector 44D can be considered the three or more types of harness connectors 44.

However, the through circuit wiring 52 connecting the engine room harness connector 44A and the door harness connector 44C may be provided in the wire harness 30. In this case, the engine room harness connector 44A, the instrument panel harness connector 44B, the door harness connector 44C, and the floor harness connector 44D are connected to each other via the through circuit wiring 52.

As illustrated in FIG. 5, some of the plurality of wirings 50 are collected herein to constitute a first wiring group 54, and the other some of the plurality of wirings 50 are collected separately from the first wiring group 54 to constitute a second wiring group 60. Herein, the plurality of wirings 50 are fixed to the base members 56 and 62 and collected. However, the configuration of collecting the plurality of wirings 50 is not limited thereto, but can be appropriately set. For example, the plurality of wiring 50 may be bundled into a circular bundle shape by a tape and collected.

A way of partitioning the plurality of wirings 50 into the first wiring group 54 and the second wiring group 60 is not particularly limited, but can be appropriately set. Herein, the plurality of wirings 50 are partitioned based on the apparatus wiring 51 and the through circuit wiring 52. Specifically, more than half of the wirings in first wiring group 54 are the apparatus wirings 51. More than half of the wirings in second wiring group 60 are the through circuit wirings 52. 60% or more, 70% or more, 80% or more, or 90% or more of the first wiring group 54 may be the apparatus wirings 51. All (100%) of the first wiring group 54 may be the apparatus wirings 51. In the similar manner, 60% or more, 70% or more, 80% or more, or 90% or more of the second wiring group 60 may be the through circuit wirings 52. All (100%) of the second wiring group 60 may be the through circuit wirings 52.

In the example illustrated in FIG. 5, all (100%) of the first wiring group 54 are the apparatus wirings 115. 90% or more of the second wiring group 60 are the through circuit wirings 52. Provided to the second wiring group 60 is the apparatus wiring 51A connecting the engine room harness connector 44A and the apparatus connector 42 in the apparatus wirings 51. The apparatus wirings 51B, 51C, and 51D except for the apparatus wiring 51A in the apparatus wirings 51 are provided to the first wiring group 54. All of the through circuit wirings 52 are provided to the second wiring group 60.

Each of the first wiring group 54 and the second wiring group 60 are flatly formed and stacked to each other. Herein, the first wiring group 54 includes a plurality of electrical wires 55 and the flat base member 56 keeping the plurality of electrical wires 55 flat. The electrical wire 55 and the base member 56 are fixed to each other herein. The electrical wire 55 and the base member 56 may not be fixed to each other. The second wiring group 60 includes a plurality of electrical wires 61 and the flat base member 62 keeping the plurality of electrical wires 61 flat. The electrical wire 61 and the base member 62 are fixed to each other herein. The electrical wire 61 and the base member 62 may not be fixed to each other. Each of the electrical wires 55 and 61 are insulated electrical wires each including a core wire and a covering layer covering the core wire. The insulated electrical wire may include a covering layer which is extrusion molded. The insulated electrical wire may be an enamel electrical wire. Each of the base members 56 and 62 may be a member made of resin or metal, or may also be a composite member including both a portion made of resin and a portion made of metal. The description hereinafter is focused on a relationship between the electrical wire 55 in the first wiring group 54 and the base member 56. The relationship between the electrical wire 55 in the first wiring group 54 and the base member 56 can be applied to a relationship between the electrical wire 61 in the second wiring group 60 and the base member 62.

The plurality of electrical wires 55 are arranged side by side on a main surface of the base member 56. Each electrical wire 55 is fixed to the base member 56, thus a parallel state is maintained. A fixing state of the electrical wire 55 and the base member 56 is not particularly limited, but can be appropriately set. The electrical wire 55 and the base member 56 may be fixed by fusion, for example. In this case, resin included in at least one of the covering of the electrical wire 55 and/or the main surface of the base member 56 is melted, and bonded and fixed to a surface of a counterpart member. The electrical wire 55 and the base member 56 may be attached by an adhesive material or a gluing material, for example.

In the first wiring group 54, the electrical wires 55 are disposed so as not to intersect with each other on the base member 56. Also in the second wiring group 60, the electrical wires 61 are disposed so as not to intersect with each other on the base member 62. Accordingly, increase of the thickness of each of the first wiring group 54 and the second wiring group 60 is suppressed, and increase of the thickness of the wire harness 30 in which the first wiring group 54 and the second wiring group 60 are stacked to each other is suppressed. However, in at least one of the first wiring group 54 and/or the second wiring group 60, an intersection part where the electrical wires intersect with each other on the base member may also be provided.

The base members 56 and 62 may be flexible sheet members 56 and 62. Each of the sheet members 56 and 62 may be a sheet including a fiber material such as a non-woven cloth, for example. Each of the sheet members 56 and 62 may be the sheet having a filled cross-sectional surface. The sheet members 56 and 62 have flexibility so as to be able to follow bending of the electrical wires 55 and 61.

Herein, a part of the wire harness 30 is disposed along the dashboard panel 11. A wiring part extending from the engine room harness connector 44A is held to be disposed along the dashboard panel 11.

The other part of the wire harness 30 is disposed along the cowl side panel 15. The instrument panel harness connector 44B, the door harness connector 44C, and the floor harness connector 44D are held so that they are arranged in a height direction and a wiring part extending from each of the instrument panel harness connector 44B, the door harness connector 44C, and the floor harness connector 44D are disposed along the cowl side panel 15.

In the wire harness 30, the electrical wire 61 and the sheet member 62 are disposed in a bended state in a thickness direction between a portion disposed along the dashboard panel 11 and a portion disposed along the cowl side panel 15. Herein, the portion disposed along the dashboard panel 11 is only the second wiring group 60 in the first wiring group 54 and the second wiring group 60. Thus, the wire harness 30 is easily bended in the thickness direction between the portion disposed along the dashboard panel 11 and the portion disposed along the cowl side panel 15.

As illustrated in FIG. 6, the first wiring group 54 and the second wiring group 60 are stacked so that a main surface of the base member 56 to which the electrical wire 55 is fixed and a main surface of the base member 62 to which the electrical wire 61 is fixed face each other. Accordingly, the electrical wires 55 and 61 are surrounded and protected by the base members 56 and 62. However, it is also applicable that the first wiring group 54 and the second wiring group 60 are stacked so that a main surface of the base member 56 to which the electrical wire 55 is fixed and a main surface of the base member 62 to which the electrical wire 61 is not fixed face each other, or are stacked so that a main surface of the base member 62 to which the electrical wire 61 is fixed and a main surface of the base member 56 to which the electrical wire 55 is not fixed face each other. The first wiring group 54 and the second wiring group 60 may be stacked so that a main surface of the base member 56 to which the electrical wire 55 is not fixed and a main surface of the base member 62 to which the electrical wire 61 is not fixed face each other.

The first wiring group 54 and the second wiring group 60 are stacked so that the electrical wire 55 and the electrical wire 61 are overlapped with each other. The electrical wires 55 and 61 have two stages made up of the electrical wire 55 in one stage and the electrical wire 61 in one stage overlapped with each other. There may be a case where a width dimension is desired to be reduced in at least a part of the wire harness 30 even when a thickness dimension increases to some extent depending on a space where the wire harness 30 is disposed. In such a case, the electrical wires 55 and 61 may be stacked in three or more stages, for example. It is also applicable that the base members 56 and 62 are not provided but the electrical wires 55 and 61 are bundled to have a circular shape in cross section by a banding member such as a tape, for example.

The base member 56 includes an extension piece 56a. The extension piece 56a is provided on both sides of a portion where the electrical wire 55 is disposed. The base member 62 also includes an extension piece 62a similar to the extension piece 56a. When the extension piece 56a of the base member 56 and the extension piece 62a of the base member 62 are fixed to each other, the first wiring group 54 and the second wiring group 60 are fixed to each other. However, the extension piece 56a of the base member 56 and the extension piece 62a of the base member 62 need not be fixed to each other.

The connector 40 may be held by the base members 56 and 62. It is also applicable that the electrical wires 55 and 61 extend from end portions of the base members 56 and 62, and the connector 40 are provided away from the base members 56 and 62.

A length of each of the plurality of wirings 50 is equal to or smaller than one meter. In the wire harness 30, the longest wiring 50 is the through circuit wiring 52B connecting the engine room harness connector 44A and the floor harness connector 44D or the through circuit wiring 52C connecting the instrument panel harness connector 44B and the floor harness connector 44D. A length of each of these through circuit wirings 52B and 52C is equal or smaller than one meter.

### <Effect Etc.>

According to the wire harness 30 having the above configuration, by applying the wire harness 30 according to the present disclosure including the plurality of apparatus wirings 51 connecting the apparatus connector 42 to the plural types of harness connectors 44 and the through circuit wiring 52 connecting the first harness connector 44X to the second harness connector 44Y in the plural types of harness connectors 44 as the plurality of wirings 50, simplified is connection between the plural types of counterpart wire harness 20 and connection between the plural types of counterpart wire harness 20 and the apparatus 22.

Some of the plurality of wirings 50 are collected to constitute the first wiring group 54, and the other some of the plurality of wirings 50 are collected separately from the first wiring group 54 to constitute the second wiring group 60. Accordingly, the first wiring group 54 and the second wiring group 60 can be separately manufactured, and can be subsequently integrated to constitute the wire harness 30.

Each of the first wiring group 54 and the second wiring group 60 are flatly formed and stacked to each other. Accordingly, the wire harness 30 can also be easily disposed in a narrow position in the vehicle 10.

Each of the first wiring group 54 and the second wiring group 60 includes the plurality of electrical wires 55 and 61 and the flat base members 56 and 62 keeping the plurality of electrical wires 55 and 61 flat. Accordingly, each of the flat first wiring group 54 and second wiring group 60 is simply provided.

More than half of the wirings in first wiring group 54 is the plurality of apparatus wirings 51, and more than half of the wirings in second wiring group 60 is the through circuit wirings 52. Accordingly, most of the apparatus wirings 51 and most of the through circuit wirings 52 can be separated. Suppressed is intersection of the apparatus wiring 51 and the through circuit wiring 52 on the base member 56 and 62 where the apparatus wiring 51 and the through circuit wiring 52 are fixed, respectively. Accordingly, suppressed is increase of thickness of each of the first wiring group 54 and the second wiring group 60.

Three or more types of harness connectors 44 are provided as the plural types of harness connectors 44. Accordingly, three or more types of counterpart wire harness 20 and the apparatus 22 can be connected by the wire harness 30.

A length of each of the plurality of wirings 50 is equal to or smaller than one meter. Accordingly, the wire harness 30 can connect the apparatus 22 and the counterpart wire harness 20 in a narrow area in the vehicle 10.

The arrangement area in the vehicle 10 is the area where the dashboard panel 11 and the cowl side panel 15 intersect with each other, and two or more types of harness connectors selected from the engine room harness connector 44A, the instrument panel harness connector 44B, the door harness connector 44C, and the floor harness connector 44D are provided as the plural types of harness connectors 44. Accordingly, an operation of connecting the plural types of connectors 40 is simply performed in the narrow area where the dashboard panel 11 and the cowl side panel 15 intersect with each other in the vehicle 10.

The wiring part extending from the engine room harness connector 44A is held to be disposed along the dashboard panel 11, the instrument panel harness connector 44B, the door harness connector 44C, and the floor harness connector 44D are held so that they are arranged in the height direction, and the wiring parts extending from each of the instrument panel harness connector 44B, the door harness connector 44C, and the floor harness connector 44D are disposed along the cowl side panel 15. Accordingly, the instrument panel harness 20B, the engine room harness 20A, the door harness 20C, and the floor harness 20D, can be connected to the engine room harness connector 44A, the instrument panel harness connector 44B, the door harness connector 44C, and the floor harness connector 44D at the positions close to the arrangement areas of the instrument panel harness 20B, the engine room harness 20A, the door harness 20C, and the floor harness 20D themselves, respectively.

### [Appendix]

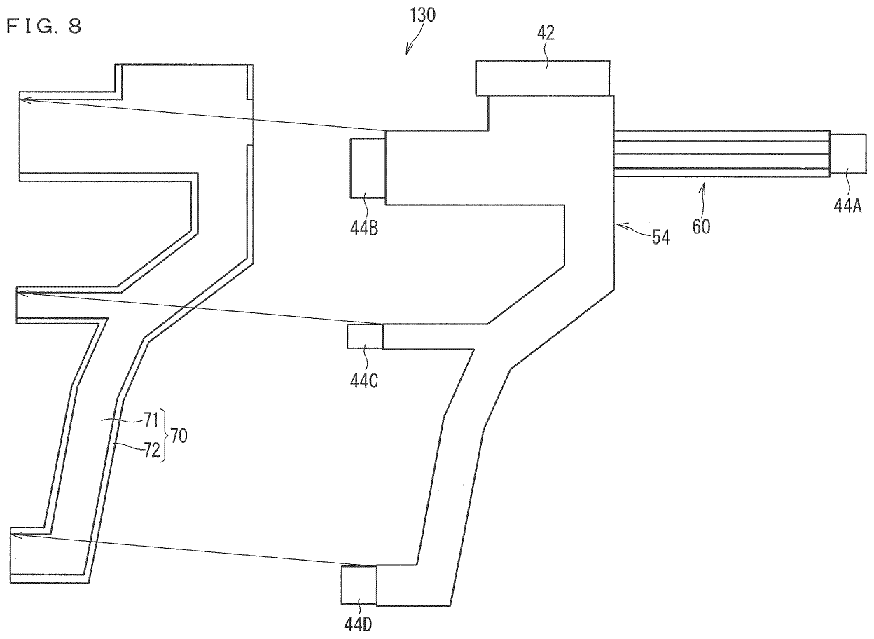

FIG. 7 is a cross-sectional view illustrating a wire harness 130 according to a first modification example. FIG. 8 is an exploded plan view illustrating a wire harness 130 according to a first modification example.

The wire harness 130 according to the first modification example is different from the wire harness 30 described above in that the wire harness 130 further includes a rigid member 70. The rigid member 70 has higher rigidity than the sheet members 56 and 62. The rigid member 70 keeps a wiring form of the first wiring group 54 and the second wiring group 60. Accordingly, the rigid member 70 is disposed in the vehicle 10, thus the wiring 50 can be disposed along a predetermined route. The rigid member 70 may be formed by metal or rigid resin, for example.

A position where the rigid member 70 is provided in the wire harness 30 is not particularly limited, but can be appropriately set. Herein, the rigid member 70 is provided in a part of the wire harness 130 disposed along the cowl side panel 15. The rigid member 70 is not provided to a part of the wire harness 130 disposed along the dashboard panel 11.

The rigid member 70 is provided to cover a whole part of the wire harness 130 disposed along the cowl side panel 15. The rigid member 70 may be provided to cover a part of the wire harness 130 disposed along the cowl side panel 15. For example, the rigid member 70 may be provided to cover a part located on an upper side along a vertical direction (herein, a part extending from the instrument panel harness connector 44B and a part extending from the apparatus connector 42).

The rigid member 70 may be disposed between the wire harness 130 and the cowl side panel 15. The wire harness 130 may be disposed between the rigid member 70 and the cowl side panel 15.

A shape of the rigid member 70 is not particularly limited, but can be appropriately set. Herein, the rigid member 70 has a bucket shape including a bottom part 71 and a sidewall 72. The first wiring group 54 and the second wiring group 60 are housed in a housing part surrounded by the bottom part 71 and the sidewall 72. The rigid member 70 may include a cover covering an opening of the housing part. It is also applicable that the rigid member 70 does not include the sidewall 72 but includes only the bottom part 71.

It is also applicable that the wire harness 30 does not include the flexible sheet member as the base member but includes the rigid member 70 as the base member in place of the sheet member. In the rigid member 70, a partition wall may be provided between a pair of sidewalls 72. Accordingly, a plurality of housing parts are provided to the rigid member. It is applicable in this case that some of the plurality of wirings are housed in a first housing part to constitute a first wiring group and the other some of the plurality of wirings are housed in a second housing part to constitute a second wiring group. For example, the apparatus wiring and the through circuit wiring may be separately housed in the plurality of housing parts. For example, a power source line and a signal line may be separately housed in the plurality of housing parts.

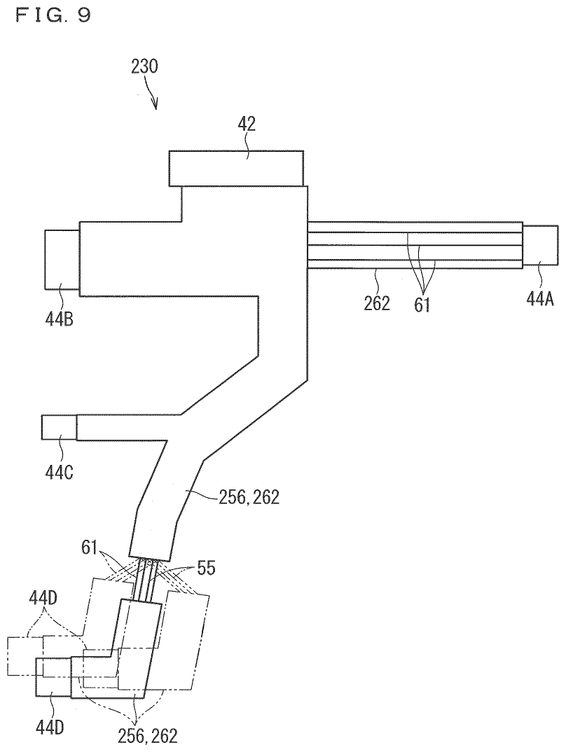

FIG. 9 is a plan view illustrating a wire harness 230 according to a second modification example.

Positions where base members 252 and 262 are provided in the wire harness 230 according to the second modification example are different from positions where the base members 56 and 62 are provided in the wire harness 30 described above. Specifically, the plurality of base members 256 and 262 are provided at intervals along an extension direction of the plurality of electrical wires 55 and 61 in positions corresponding to the first wiring group 54 and the second wiring group 60, respectively. More specifically, the base member 256 is separated into a part on one end and a part on the other end in the extension direction of the electrical wire 55, and the separated parts are provided at an interval along the extension direction of the electrical wire 55 with the corresponding part therebetween. The base member 262 is separated into a part on one end and a part on the other end in the extension direction of the electrical wire 61, and the separated parts are provided at an interval along the extension direction of the electrical wire 61 with the corresponding part therebetween. Accordingly, the plurality of electrical wires 55 and 61 are easily bended in the portion between the plurality of base members 256 and 262 compared with the portion where the plurality of base members 256 and 262 are provided, and a difference of route or redundant length can be easily absorbed. Accordingly, the common wire harness 230 can be easily applied to vehicle having different sizes.

Herein, a section where the base members 256 and 262 are disconnected in an intermediate part of the wiring 50 along the extension direction thereof is provided to a part of the wire harness 230 disposed along the cowl side panel 15 and extending a vertical direction. In this case, the wire harness 230 is easily applied to plural types of vehicle each having a height dimension different from each other. In this case, the wire harness 230 is formed in accordance with a vehicle having a large height. When the wire harness 230 is applied to a vehicle having a small height, the electrical wires 55 and 61 are bended in a section where the base members 256 and 262 are disconnected, and a redundant length is absorbed. For example, the section where the base members 256 and 262 are disconnected may be provided between the door harness connector 44C and the floor harness connector 44D.

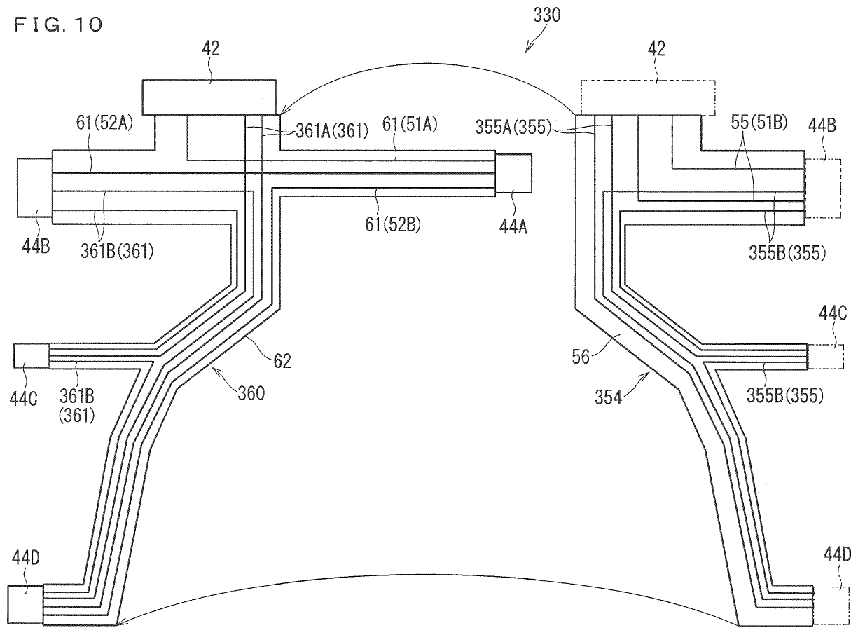

FIG. 10 is an exploded plan view illustrating a wire harness 330 according to a third modification example.

A configuration of dividing the wirings into a first wiring group 354 and a second wiring group 360 in the wire harness 330 according to the third modification example is different from a configuration of dividing the wirings into the first wiring group 54 and the second wiring group 60 in the wire harness 30 described above. Herein, the wirings 50 are divided into the first wiring group 354 and the second wiring group 360 based on whether the wirings 50 are signal lines 355 or power source lines 361. Specifically, more than half of the wirings in first wiring group 354 are the signal lines 355. A ratio of the power source lines 361 in the second wiring group 360 is higher than that of the power source lines in the first wiring group 354. Accordingly, most of the power source lines 361 and most of the signal lines 355 can be separated.

The ratio of the power source line 361 in the second wiring group 360 is not particularly limited, but can be appropriately set. For example, the ratio of the power source line 361 in the second wiring group 360 may be equal to or larger than 50% or smaller than 50%. That is to say, more than half of the wirings in second wiring group 360 may be the power source lines 361 or signal lines.

More than half of all the power source lines in the wire harness 330 may be disposed in the second wiring group 360. More than half of all the signal lines in the wire harness 330 may be disposed in the first wiring group 354. The second wiring group 360 may or may not include the signal line. The first wiring group 354 may or may not include the power source line.

In the example illustrated in FIG. 10, the power source line 361 in the wirings 50 connected to the door harness connector 44C and the wirings 50 connected to the floor harness connector 44D is provided in the second wiring group 360, and the signal line 355 is provided in the first wiring group 354. A power source line 361A in the second wiring group 360 connects each of the door harness connector 44C and the floor harness connector 44D to the apparatus connector 42. A power source line 361B in the second wiring group 360 connects each of the door harness connector 44C and the floor harness connector 44D to the other harness connector 44. A signal line 355A in the first wiring group 354 connects each of the door harness connector 44C and the floor harness connector 44D to the apparatus connector 42. A signal line 355B in the first wiring group 354 connects each of the door harness connector 44C and the floor harness connector 44D to the other harness connector 44.

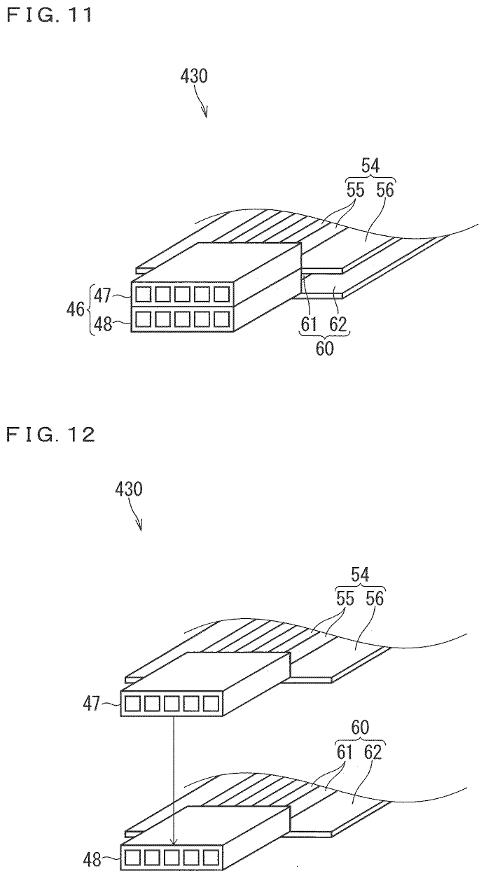

FIG. 11 is a perspective view illustrating a wire harness 430 according to a fourth modification example. FIG. 12 is an exploded perspective view illustrating the wire harness 430 according to the fourth modification example.

A shape of a connector 46 in the wire harness 430 according to the fourth modification example is different from the shape of the connector 40 in the wire harness 30 described above. Specifically, at least one type of connector 46 in the plural types of connectors 40 is made up of a plurality of split connectors 47 and 48. The plurality of split connectors 47 and 48 include a first split connector 47 and a second split connector 48. The wiring 50 of the first wiring group 54 is connected to the first split connector 47. The wiring of the second wiring group 60 is connected to the second split connector 48. Accordingly, an operation of inserting one of the wiring 50 of the first wiring group 54 and the wiring 50 of the second wiring group 60 into the connector 40 into which the other one of wiring 50 of the first wiring group 54 and the wiring 50 of the second wiring group 60 is previously inserted hardly occurs compared with the case of the wire harness 30. Accordingly, it is easy to separately manufacture the first wiring group 54 and the second wiring group 60 and subsequently integrate them to constitute the wire harness 430.

Herein, the first split connector 47 and the second split connector 48 are integrated to constitute a stacked connector 46. Accordingly, at least one type of connector 46 in the plural types of connectors 40 is the stacked connector 46 made up of the plurality of split connectors 47 and 48 integrated with each other. Each type of connector 40 may be divided in a form other than the stacked connector 46. For example, the apparatus connector 42 may be divided into a plurality of split connectors arranged in a direction intersecting with the thickness direction. It is also applicable that two division connectors are not integrated but are connected to the apparatus 22.

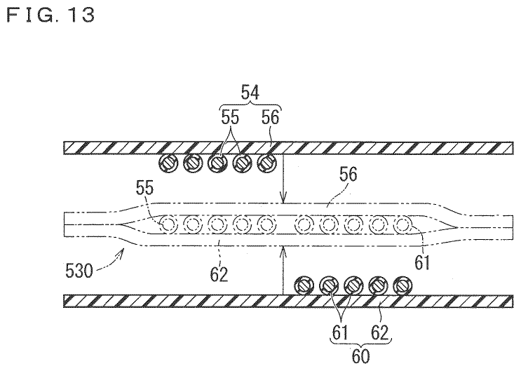

FIG. 13 is a cross-sectional view illustrating a wire harness 530 according to a fifth modification example.

A lamination form of the first wiring group 54 and the second wiring group 60 in the wire harness 530 according to the fifth modification example is different from the lamination form of the wire harness 530 described above. The wiring 50 of the first wiring group 54 and the wiring 50 of the second wiring group 60 are disposed to deviate in a parallel direction so as not to be stacked to each other in the portion where the first wiring group 54 and the second wiring group 60 are stacked to each other. Accordingly, a thickness of the wire harness 530 in which the first wiring group 54 and the second wiring group 60 are stacked is reduced compared with the case where the wiring 50 of the first wiring group 54 and the wiring 50 of the second wiring group 60 are stacked to each other. Multilayer configuration of the wiring 50 is suppressed, thus the wire harness 530 is easily bended in the thickness direction. The lamination form may be provided in a part of the wire harness 530, or may also be provided to the whole wire harness 530. For example, the lamination form may be provided in a part of the wire harness 530 extending from the door harness connector 44C.

In the above description, moreover, the plurality of wirings 50 constitute the first wiring group 54 and the second wiring group 60, however, this configuration is not necessary. It is also applicable that the plurality of wirings 50 do not constitute the first wiring group 54 and the second wiring group 60, but are collected in a bundle.

Moreover, at least some of the plural types of connectors 40 may be standby connectors. For example, at least some of the plural types of harness connectors 44 may be a standby connector. Accordingly, the counterpart wire harness can be easily connected to the harness connector 44.

The arrangement area of the wire harness 30 may be an area close to a rear seat or a rear luggage, for example. In this case, a floor harness, a sheet harness, or a rear harness, for example, are assumed as the counterpart wire harness 20.

The configurations described in the embodiments and modification examples thereof can be appropriately combined as long as they are not contradictory.

### EXPLANATION OF REFERENCE SIGNS

10 vehicle
11 dashboard panel
12 body part
13 protrusion part
14 through hole
15 cowl side panel
16 through hole
17 instrument panel reinforcement
18 floor panel
18a rocker part
19 A pillar
20 counterpart wire harness
20A engine room harness
20B instrument panel harness
20C door harness
20D floor harness
20E roof harness
20X first counterpart wire harness
20Y second counterpart wire harness
22 apparatus
30, 130, 230, 330, 430, 530 wire harness
40 connector
42 apparatus connector
44 harness connector
44A engine room harness connector
44B instrument panel harness connector
44C door harness connector
44D floor harness connector
44E roof harness connector
44X first harness connector
44Y second harness connector
46 stacked connector
47 first split connector
48 second split connector
50 wiring
51, 51A, 51B, 51C, 51D apparatus wiring
51X first apparatus wiring
51Y second apparatus wiring
52, 52A, 52B, 52C, 52D, 52E through circuit wiring
54, 354 first wiring group
55 electrical wire
355, 355A, 355B signal line
56, 256 base member (sheet member)
56a extension piece
60, 360 second wiring group
61 electrical wire
361, 361A, 361B power source line
62, 262 base member (sheet member)
62a extension piece
70 rigid member
71 bottom part
72 sidewall

1. A wire harness, comprising:
plural types of connectors connected to connection destinations different from each other; and
a plurality of wirings connecting the plural types of connectors to each other, wherein
the plural types of connectors include an apparatus connector connected to a connector of an apparatus and plural types of harness connectors to which connectors of counterpart wire harnesses different from each other are connected, respectively,
the plurality of wirings include at least one through circuit wiring connecting a first harness connector and a second harness connector in the plural types of harness connectors and a plurality of apparatus wirings connecting the apparatus connector to the first harness connector and the second harness connector, and
the through circuit wiring is not short-circuited to a circuit of the apparatus wiring inside the first harness connector but is connected to the counterpart wire harness connected to the first harness connector, and is not short-circuited to a circuit of the apparatus wiring inside the second harness connector but is connected to the counterpart wire harness connected to the second wire harness connector.

2. The wire harness according to claim 1, wherein
some of the plurality of wirings are collected to constitute a first wiring group and another some of the plurality of wirings are collected separately from the first wiring group to constitute a second wiring group.

3. The wire harness according to claim 2, wherein
each of the first wiring group and the second wiring group is flatly formed and stacked to each other.

4. The wire harness according to claim 3, wherein
each of the first wiring group and the second wiring group includes a plurality of electrical wires and at least one flat base member keeping the plurality of electrical wires flat.

5. The wire harness according to claim 4, wherein
the plurality of base members are provided at intervals along an extension direction of the plurality of electrical wires in a position corresponding to each of the first wiring group and the second wiring group.

6. The wire harness according to claim 4, wherein
the base member is a flexible sheet member, and
the wire harness further includes a rigid member having higher rigidity than the sheet member and holding a wiring form of the first wiring group and the second wiring group.

7. The wire harness according to claim 2, wherein
more than half of the wirings in first wiring group is the apparatus wirings, and
more than half of the wirings in second wiring group is the through circuit wirings.

8. The wire harness according to claim 2, wherein
more than half of the wirings in first wiring group is signal lines, and
a ratio of power source lines in the second wiring group is higher than a ratio of power source lines in the first wiring group.

9. The wire harness according to claim 2, wherein
at least one of the plural types of connectors is made up of a plurality of split connectors, and
the plurality of split connectors include a first split connector to which the first wiring group is connected and a second split connector to which the second wiring group is connected.

10. A wire harness, comprising:
plural types of connectors connected to connection destinations different from each other; and
a plurality of wirings connecting the plural types of connectors to each other, wherein
the plural types of connectors include an apparatus connector connected to a connector of an apparatus and plural types of harness connectors to which connectors of counterpart wire harnesses different from each other are connected, respectively,
the plurality of wirings include at least one through circuit wiring connecting a first harness connector and a second harness connector in the plural types of harness connectors and a plurality of apparatus wirings connecting the apparatus connector to the first harness connector and the second harness connector, and
three or more types of harness connectors are provided as the plural types of harness connectors.

11. The wire harness according to claim 1, wherein
a length of each of the plurality of wirings is equal to or smaller than one meter.

12. A wire harness, comprising:
plural types of connectors connected to connection destinations different from each other; and
a plurality of wirings connecting the plural types of connectors to each other, wherein
the plural types of connectors include an apparatus connector connected to a connector of an apparatus and plural types of harness connectors to which connectors of counterpart wire harnesses different from each other are connected, respectively,
the plurality of wirings include at least one through circuit wiring connecting a first harness connector and a second harness connector in the plural types of harness connectors and a plurality of apparatus wirings connecting the apparatus connector to the first harness connector and the second harness connector,
an arrangement area in a vehicle is an area where a dashboard panel and a cowl side panel intersect with each other, and
two or more types of harness connectors selected from an engine room harness connector, an instrument panel harness connector, a door harness connector, and a floor harness connector are provided as the plural types of harness connectors.

13. The wire harness according to claim 12, wherein
the engine room harness connector, the instrument panel harness connector, the door harness connector, and the floor harness connector are provided as the plural types of harness connectors,
a wiring part extending from the engine room harness connector is held to be disposed along the dashboard panel, and
the instrument panel harness connector, the door harness connector, and the floor harness connector are arranged side by side in a height direction, and a wiring part extending from each of the instrument panel harness connector, the door harness connector, and the floor harness connector is held to be disposed along the cowl side panel.
